(19) United States
(12) Patent Application Publication
(10) Pub. No.: US 2024/0215712 A1
(43) Pub. Date: Jul. 4, 2024

(54) Tuner Caddy

(71) Applicant: Mark Caspersen, Richardson, TX (US)

(72) Inventor: Mark Caspersen, Richardson, TX (US)

(21) Appl. No.: 18/378,259

(22) Filed: Oct. 10, 2023

Related U.S. Application Data
(60) Provisional application No. 63/435,846, filed on Dec. 29, 2022.

(51) Int. Cl. A47B 19/00

(52) U.S. Cl. CPC A47B 19/002; A47B 2019/006

(57) ABSTRACT

A holder to support music equipment on music stands is disclosed. The holder includes a back plate and a front panel joined by a base ledge for supporting a music equipment therebetween, the back plate having a set of mounting structures that reversibly secure the back plate to a support structure of a music stand. The set of mounting structures includes one or more magnetic members fastened to the back plate, for magnetically securing the back plate to the support structure of the music stand.

The present application claims priority to the earlier filed provisional application having Ser. No. 63/435,846, and hereby incorporates subject matter of the provisional application in its entirety.

### FIELD OF THE DISCLOSURE

The disclosure relates generally to holders for music equipment. Particularly and not exclusively, the subject matter of the instant disclosure relates to the construction and configuration of a music equipment holder for music stands for securely holding music equipment in order to facilitate a user in personal musical practice, or large rehearsals, or live performance, and prevent disruption of performance and damage to the music equipment.

### BACKGROUND OF THE DISCLOSURE

Organizers of live music performances employ music stands for holding sheets of music or other instruments used by musicians. Typically, when it is necessary to hold music equipment such as tuners or smartphones, musicians often place the music equipment on the ledge of a music stand. Music equipment are often not secured along the ledge of the music stand, making them vulnerable to fall off and get damaged, which may also cause distraction to the performer and the audience in midst of a performance. Existing solutions also are not ergonomically provided and are inconvenient to use, thereby causing neck and back strain, and present a risk of injury. Further, due to the wiring requirements of modern-day music equipment, it may also be desirable to have provisions for arranging the wires, and for placing writing instruments in a convenient manner.

Existing solutions are also not adaptable to music stands with a plurality of designs and dimensions. For instance, wired or foldable music stands often use a plurality of foldable arms of varying shapes and sizes, on which existing solutions for holding music equipment cannot be used.

Therefore, there is a need in the art for a music equipment holder for music stands.

### SUMMARY

In order to obviate the shortcomings of the background art, a reliable and effective music equipment holder is provided and illustrated in the instant disclosure.

Principally, in accordance with the most preferred embodiment of the instant disclosure, a holder to support a music equipment on a music stand is provided. The holder to support music equipment on music stands includes a back plate and a front panel joined by a base ledge for supporting a music equipment therebetween. The back plate has a set of mounting structures that reversibly secure the back plate to a support structure of a music stand. The set of mounting structures may be provided on a mounting surface of the holder.

In some embodiments, the back plate may include a set of abutments that securely engage with the music equipment to prevent said music equipment from falling off from the holder. In some embodiments, each abutment from the set of abutments may be configured on a perimeter of the back plate.

In some embodiments, the holder may further include a support panel joined to the back plate by a support ledge such that the holder is reversibly securable to the music stand by fitting a vertical planar structure of said music stand between the support panel, the support ledge and the back plate. In some embodiments, the base ledge and the support ledge may be separated by a predetermined distance to allow an elongated structure to be fitted therebetween. In some embodiments, the back plate may include a protruding ledge that engages with the vertical planar structure.

In some embodiments, the set of mounting structures may include one or more protrusions on a mounting surface of the back plate. The one or more protrusions may be contoured to receive and secure the holder with the support structure of the music stand.

In some embodiments, the set of mounting structures can include one or more magnetic members fastened to the back plate by a fastener. In some embodiments, the one or more magnetic members may be fitted into one or more protrusions on the back plate. The one or more magnetic members may be used for magnetically securing the back plate to the support structure of the music stand.

In some embodiments, the back plate may include one or more cavities that allow a set of flexible elements to be connected to the music equipment through the back plate.

In some embodiments, the set of mounting structures may include one or more gripping elements extending from the back plate. The one or more gripping elements may be capable of reversibly gripping a horizontal planar structure of the music stand. In some embodiments, the one or more gripping elements may include at least one gripping panel and at least one gripping arm that resiliently grip the horizontal planar structure of the music stand therebetween.

In some embodiments, the back plate may include one or more structural ribs configured to bias the one or more gripping elements to be resilient.

In some embodiments, each the one or more gripping elements may include a corresponding gripping ledge that prevents the horizontal planar structure from slipping out therefrom.

The following description is illustrative in nature and is not intended to be in any way limiting. In addition to the aforementioned illustrative aspects, embodiments, and features of the instant disclosure, further aspects, embodiments and features will become apparent by reference to the following detailed description.

### BRIEF DESCRIPTION OF THE ACCOMPANYING DRAWINGS

The accompanying drawings illustrate the best mode for carrying out the disclosure as instantly contemplated and set forth hereinafter. The instant disclosure may be more clearly understood from a consideration of the following detailed description of the preferred embodiments taken in conjunction with the accompanying drawings where all figures are diagrammatic and not to scale. Further, like reference letters and numerals indicate the corresponding parts in various figures in the accompanying drawings.

FIG. 1A illustrates an exemplary front view of a holder for music equipment on a music stand, according to embodiments of present disclosure.

FIG. 1B illustrates an exemplary back view of the holder for music equipment on the music stand, according to embodiments of present disclosure.

FIG. 2 illustrates an exemplary perspective view of the holder, according to embodiments of present disclosure.

FIG. 3 illustrates an exemplary front view of the holder, according to embodiments of present disclosure.

FIG. 4A illustrates an exemplary rear isometric view of the holder, according to embodiments of present disclosure.

FIG. 4B illustrates an exemplary cross-section view of the holder, according to embodiments of present disclosure.

FIGS. 5A and 5B illustrate exemplary front and rear isometric views of the holder having one or more gripping elements respectively, according to embodiments of present disclosure.

FIG. 5C illustrates an exemplary side view of the holder having the one or more gripping elements, according to embodiments of present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the disclosure as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “some embodiments” or “other embodiments” or “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Typically, music stands do not have sufficient space for supporting accessories/music equipment including tuners, phones, speakers, pens, pencils, reeds, to name a few. Such music equipment is often placed on trays or racks of the music stands along with musical sheets, thereby making them vulnerable to slip or fall out from the music stands. Placing the music equipment in such positions also are not convenient for performers. A traditional music stand may make performers slouch thereby causing unnecessary body bending during a performance. Also, a proper posture is required for any musician/performer using a music stand which, if not followed, may cause discomfort and risk injury. Bad postures may in turn cause neck or back injury to the user including temporary or recurring back pain. Therefore, it is critical for any musician or a performer who likes to keep his form, to practice with proper posture.

Accordingly, in order to overcome at least the above-mentioned drawbacks associated with the existing music stands, embodiments of a holder for supporting a music equipment on a music stand are proposed. Some of the characteristics of the proposed holder include affordability, simple construction and configuration, ease of operation, reusability, portability; and protection against injuries to the user and prevention of damage to the music equipment.

The proposed embodiments of the holder address the above-mentioned deficiencies of the existing music stands by enabling users to install a singular integrated construction with a defined pathway for wires and cables in a convenient manner for supporting music equipment on music stands, for example.

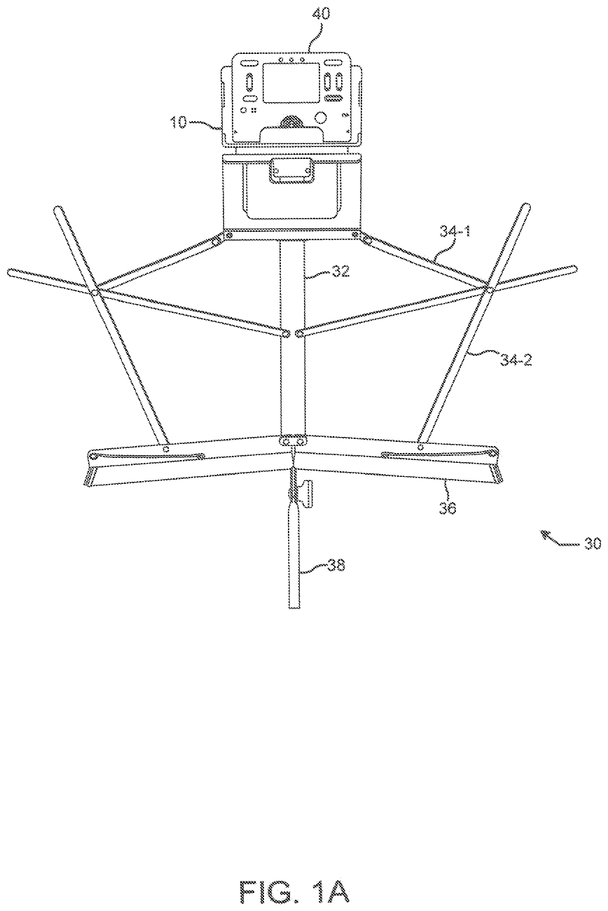

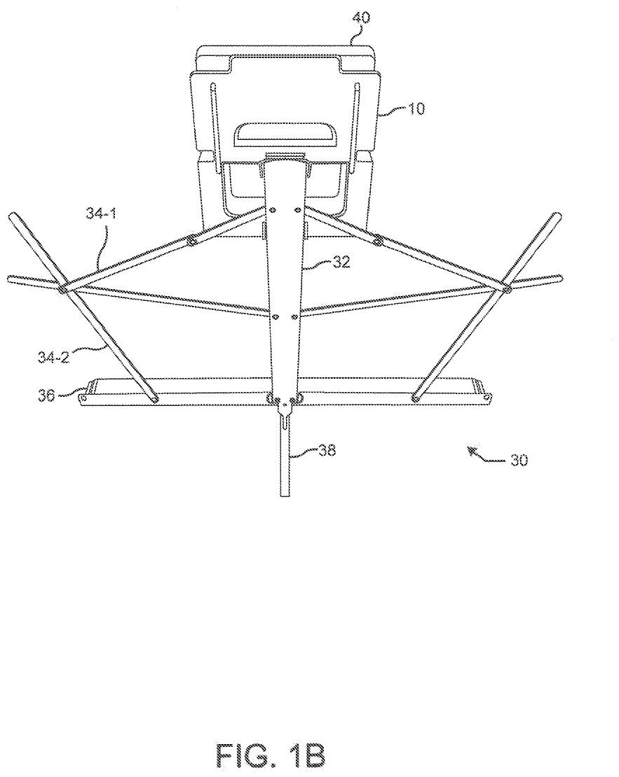

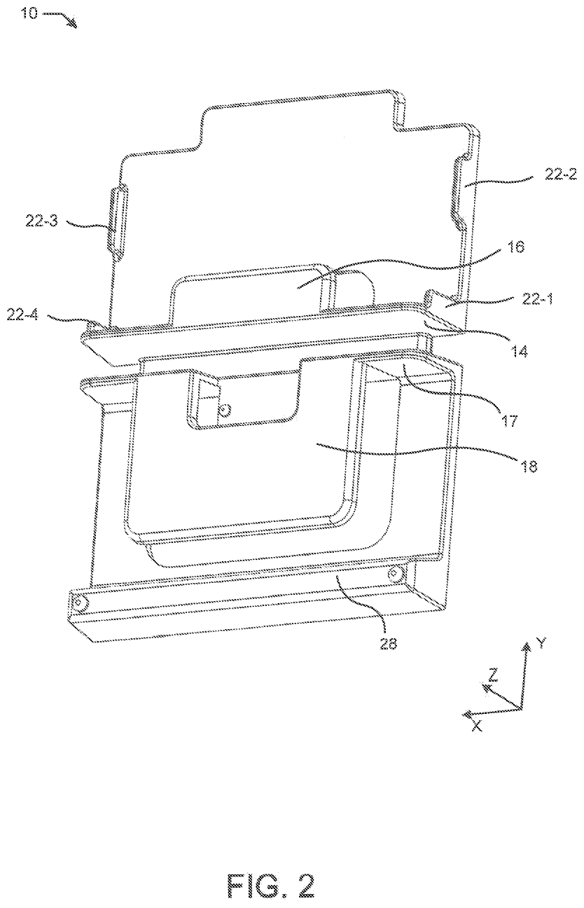

FIGS. 1A and 1B illustrate exemplary representations of a holder 10 to support a music equipment 40 on a music stand 30. The holder 10 includes a back plate 12 and a front panel 16 joined by a base ledge 14 (as subsequently shown in FIG. 2) for supporting/holding the music equipment 40 to the music stand 30. In some embodiments, the music equipment 40 may include, but not be limited to, musical instruments, tuners, smartphones, electronic display devices, handheld electronic devices, microphones, mixers, amplifiers, speakers, musical notes book or the like. The holder 10 may be suitably adapted to accommodate any other article or device having form corresponding to the holder 10. The back plate 12 has a set of mounting structures that reversibly secure the back plate 12 with a support structure 32 of the music stand 30. The set of mounting structures may be provided in a mounting surface 13 of the holder 10.

In some embodiments, the music stand 30 may be a wired or foldable music stand having a plurality of foldable arms 34 (such as foldable arms 34-1 and 34-2 of FIGS. 1A and 1B) that are supported on a support structure 32. The plurality of foldable arms 34 are moved between a retracted position and an extended position. The plurality of foldable arms 34 may be moved to the retracted position for compact packing and transporting of the music stand 30. Conversely, the plurality of foldable arms 34 may be moved to the extended position for holding sheets of music in position for reading during musical performances. The plurality of foldable arms 34 may be movably configured to the support structure 32 such that the foldable arms 34 are retractable towards the support structure 32.

The music stand 30 may include a tray 36 that can support sheets of paper (e.g., music notation sheets) thereon. The music stand 30 may be supported on a movable stand 38. The movable stand 38 allows the music stand 30 to be in an upright position. In some embodiments, the movable stand 38 may include a telescoping extension that can be operably extended or retracted into the movable stand 38 to adjust the height of the music stand 30. In some embodiments, the support structure 32 may have a substantially rectangular contour. The support structure 32 may be configured to extend from the movable stand 38. The holder 10 may be securable to support structure 32 of the music stand 30. While in the foregoing figures, the holder 10 is shown to have a substantially rectangular contour, it may be appreciated by those skilled in the art that the holder 10 may have any suitable contour or relative dimensions, depending upon the use requirements.

The holder 10 includes the back plate 12 and the front panel 16 joined by the base ledge 14 for supporting the music equipment 40 therebetween. In some embodiments, the back plate 12 and the front panel 16 may have a substantially planar surface. The base ledge 14 may be configured between an edge of the front panel 16 at a first end and a portion of the back plate 12. In some embodiments, the portion may be indicative of the middle of the back plate 12, as illustrated in FIGS. 1A-4B. In other embodiments, the portion may be indicative of an edge of the back plate 12. The music equipment 40 may be placed in the space formed between the back plate 12, the front panel 16 and the base ledge 14. The music equipment 40 may be supported by inner surfaces of the back plate 12, the front panel 16 and the base ledge 14. The holder 10 is configured and oriented in such a manner that the weight of the music equipment 40 is substantially supported by the base ledge 14, and such that the music equipment 40 rests on the front panel 16 and the back plate 12.

In some embodiments, the back plate 12 and the front panel 16 may be joined by the base ledge 14 such that said back plate 12 and said front panel 16 are substantially parallel to each other. In such embodiments, the base ledge 14 may be perpendicularly configured to the back plate 12 and the front panel 16. In other embodiments, the back plate 12 and the front panel 16 may be configured at an angle such that the music equipment 40 can be securely fitted therebetween. The music equipment 40 may be press-fitted into the space formed by the base ledge 14, the back plate 12 and the front panel 16. In an example, the back plate 12 and the front panel 16 are configured such that the distance therebetween decreases from the first end to a second end of the front panel 16. In such examples, the music equipment 40 may be securely held between said back plate 12 and the front panel 16. The contour, specification and dimensions of the back plate 12 and the front panel 16 may be suitably adapted based on the size and specification of the music equipment 40.

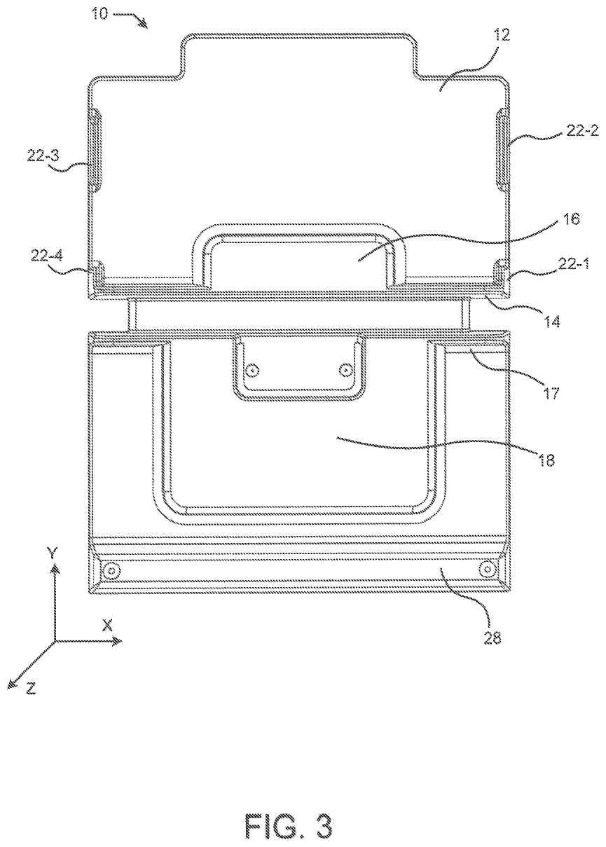

FIG. 2 and FIG. 3 illustrate exemplary perspective view and front view of the holder 10 respectively, according to embodiments of present disclosure. The back plate 12 may include a set of abutments 22 (such as the abutments 22-1, 22-2, 22-3 and 22-4) that securely engage with the music equipment 40 and prevent said music equipment 40 from falling off from the holder 10. In some embodiments, each abutment from the set of abutments 22 may be configured on a perimeter of the back plate 12 such that the music equipment 40 is prevented from falling out of the holder 10. In some embodiments, the set of abutments 22 may be configured such that the music equipment 40 may be placed into and removed from the holder 10 from a substantially vertical plane. In such embodiments, the music equipment 40 may be prevented from moving in any direction other than the vertical direction. In an example, the music equipment 40, after placement into the holder 10, may be prevented from moving or falling out of the holder 10 due to unintended collisions with the music stand 30, moving the music stand 30, or vibrations caused from sounds produced during musical performances, for instance, by the set of abutments 22.

In some embodiments, the set of abutments 22 may be indicative of protrusions from the back plate 12 that engage with and restrict movement of the music equipment 40. A first subset of abutments, such as abutments 22-1 and 22-4, may be configured to prevent horizontal movement of the music equipment 40. A second subset of abutments, specifically abutments 22-2 and 22-3, are positioned at the corners of the back plate 12 to prevent the music equipment 40 from tilting or slipping. The second subset of abutments may have a rectangular contour to provide additional stability and support. The contours and dimensions of the abutments 22 may be suitably adapted based on the dimensions of the back plate 12 and position of said abutments 22 on the back plate 12.

In some embodiments, the back plate 12 includes a support panel 18 joined to said back plate 12 by a support ledge 17 such that the holder 10 is reversibly securable to the music stand 30 by fitting a substantially vertical planar structure of said music stand 30 between the support panel 18, the support ledge 17 and the back plate 12. The substantially vertical planar structure may be indicative of including, but not limited to, shelf plates, vertically extending ledges, and the like. The support panel 18 and the support ledge 17 are configured such that when the holder 10 is secured to the music stand 30, the weight of the holder 10 is supported by the support ledge 17. The support panel 18 and the back plate 12 engage with the substantially vertical planar structure to align the back plate 12 with the substantially vertical planar structure. In some embodiments, the back plate 12 may include a protruding ledge 28 that engages with the substantially vertical planar structure such that the back plate 12 is substantially aligned with said substantially vertical planar structure. In some embodiments, the protruding ledge 28 may opposingly engage with the substantially vertical planar structure such that the back plate 12, the support panel 18, the support ledge 17, and the protruding ledge 28 are capable of reversibly gripping the substantially vertical planar structure therebetween to secure the holder 10 to the music stand 30.

In some embodiments, the base ledge 14 and the support ledge 17 may be separated by a predetermined distance such that an elongated structure can be press-fitted between the base ledge 14 and the support ledge 17. The elongated structure may include, but is not limited to, pens, pencils, cables, clips, wires, and the like. In some embodiments, at least one dimension of the elongated structure may be substantially equivalent to the predetermined distance.

In some embodiments, the back plate 12 includes one or more cavities 23 (such as cavities 23-1 and 23-2) that allow a set of flexible elements to be connected to the music equipment 40. The flexible members may be any one or more of wires, cables, tubes, but not limited thereto. In some embodiments, each of the cavities 23 may have identical contours. In some embodiments, the plurality of cavities 23 may be evenly spaced on the back plate 12.

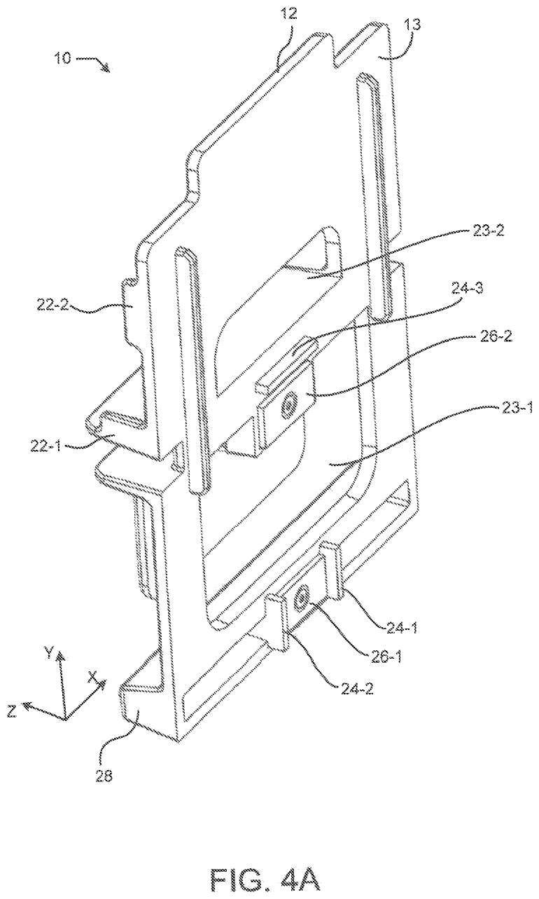

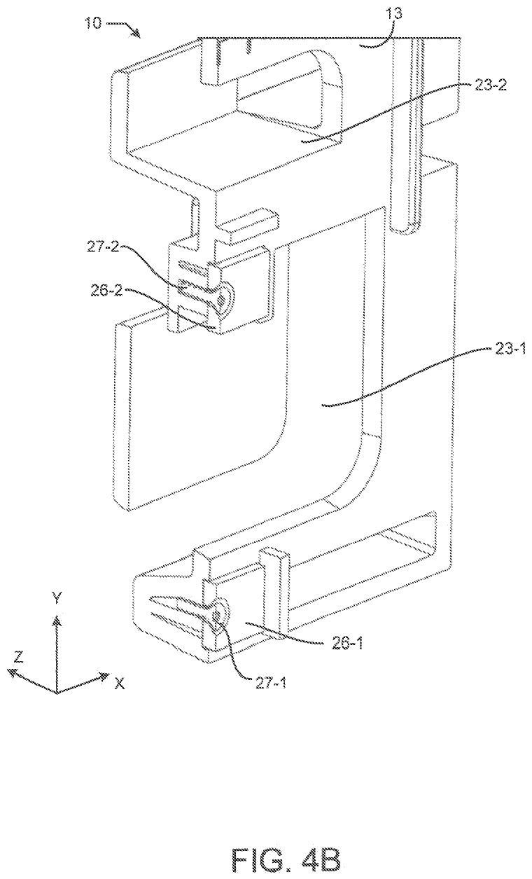

FIG. 4A and FIG. 4B provide an exemplary rear isometric view and a cross-section view of the holder 10 respectively, according to embodiments of present disclosure. The back plate 12 includes the mounting surface 13 having the set of mounting structures that reversibly secure the back plate 12 to the support structure 32 of the music stand 30. In some embodiments, the mounting surface 13 may be indicative of the surface of the back plate 12 that is opposite to the surface of the back plate 12 having the base ledge 14 or the support ledge 17.

In some embodiments, the set of mounting structures may include any one or more of magnetic members (such as magnetic members 26), screws, nails, rivets, adhesives, hook and loop fasteners, hook and slot fasteners, friction-grip releasable fasteners, and fastening straps. Friction-grip releasable fasteners may include clips, clamps, grippers, and the like. Fastening straps are indicative of ropes, straps, bands, and other flexible elements that may be wrapped around the holder 10 and the support structure 32 for securing. The holder 10 may be secured to the support structure 32 using any one of the mounting structures.

In some embodiments, the set of mounting structures may include one or more protrusions 24 (such as protrusions 24-1, 24-2 and 24-3 of FIGS. 4A and 4B) on the mounting surface 13. The one or more protrusions 24 may be contoured to receive and secure the holder 10 to the support structure 32 of the music stand 30. In some embodiments, the support structure 32 may be engaged with and fitted between the one or more protrusions 24. In other embodiments, the one or more protrusions 24 may form a slot with contours that correspond to the dimensions of the support structure 32. In such embodiments, the support structure 32 may be inserted into the slot such that said slot supports the weight of the holder 10. The slot may reversibly secure the holder 10 to the support structure 32.

In some embodiments, the set of mounting structures may include one or more magnetic members 26 (such as the magnetic members 26-1 and 26-2 as shown in FIGS. 4A and 4B) fastened thereto, for magnetically securing the back plate 12 to the support structure 32 of the music stand 30. The magnetic members 26 may be any one or combination of including, but not limited to, permanent magnets, temporary magnets, electromagnets, and the like.

In embodiments where the mounting structures are indicative of magnetic members 26, said magnetic members 26 may be fastened to the back plate 12 by a fastener 27. The fastener 27 may be any one or combination of including, but not limited to, screws, nails, rivets, welds, adhesives, friction-grip release fasteners, hook and loop fasteners, hook and slot fasteners, and the like. FIG. 4B. illustrates an embodiment where the fastener 27-1 and 27-2 corresponding to the magnetic elements 26-1 and 26-2 respectively are indicative of screws. In some embodiments, the magnetic members 26 may be integrally affixed or fitted to the back plate 12. In some embodiments, the magnetic members 26 may be press-fitted into the one or more protrusions 24 of the back plate 12.

In some embodiments, the support structures 32 of the music stand 30 may be made of materials capable of being magnetized or attracted by a magnetic force. In some embodiments, the support structures 32 may be made of ferromagnetic materials. In some embodiments, the support structures 32 of the music stand 30 may include a corresponding set of magnetic elements affixed thereto. In such embodiments, the polarity of the set of magnetic elements may correspond to the polarity of the magnetic members 26 fastened to the holder 10. In some embodiments, the set of magnetic elements may be removably configured to the support structures 32. Such embodiments may find applications when the support structure 32 is made of materials incapable of being magnetized by the magnetic members 26.

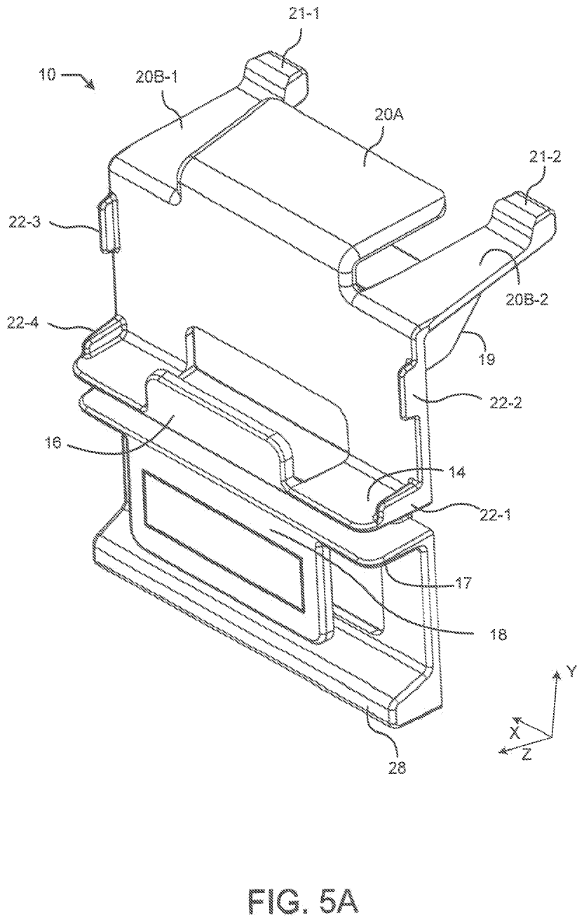

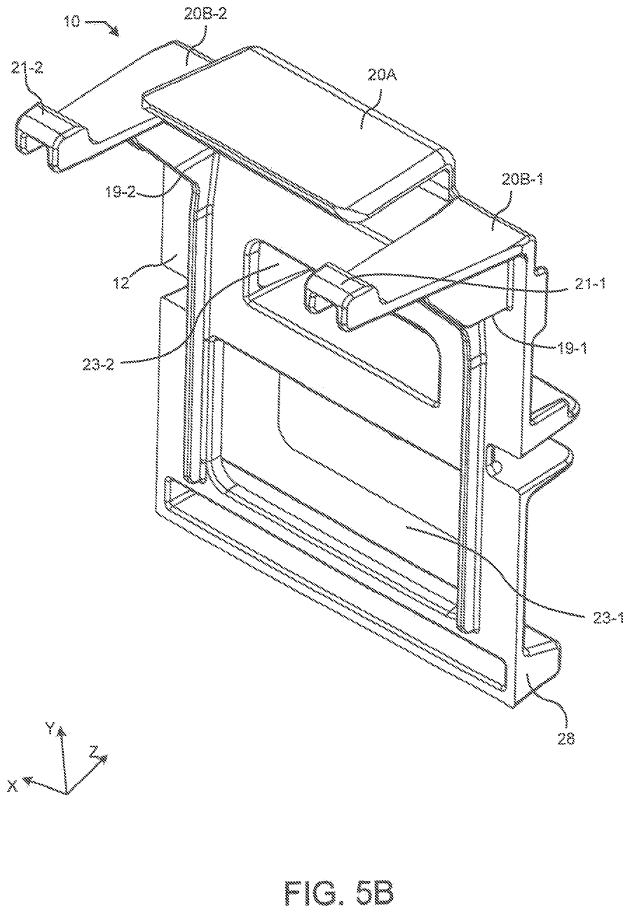

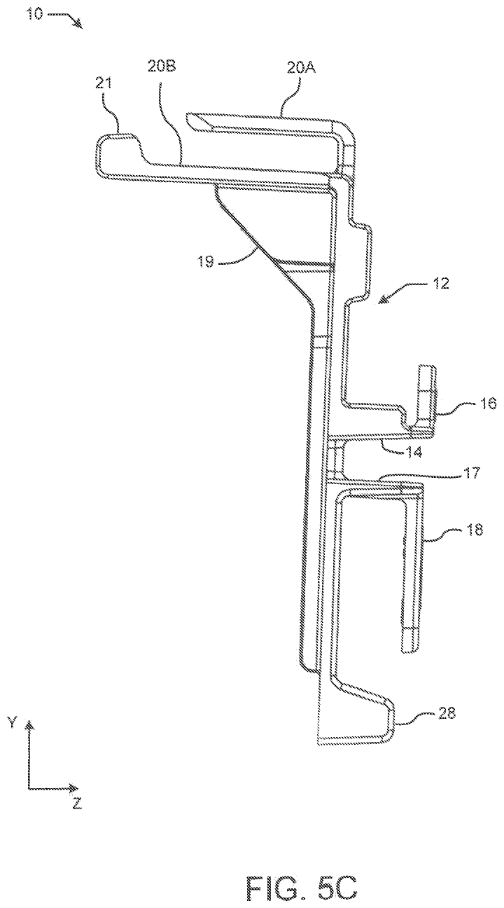

FIGS. 5A-5C illustrate an exemplary embodiment of the holder 10 having one or more gripping elements, according to embodiments of present disclosure. As shown, the set of mounting structures may include the one or more gripping elements, such as a gripping panel 20A and one or more gripping arms 20B-1 and 20B-2, extending from the back plate 12. While FIGS. 5A and 5B show a holder 10 having two gripping arms 20B and one gripping panel 20A, it may be understood by those skilled in the art that the holder 10 may be suitably adapted to have any number of gripping arms 20B and gripping panels 20A based on requirements. In some embodiments, at least two of the gripping elements may resiliently flex to accommodate and grip a substantially horizontal planar structure of the music stand 30 therebetween. The substantially horizontal planar structure may be indicative of including, but not limited to, tray 36, racks, and the like. In an example, the substantially horizontal planar structure may be inserted into the space between the gripping panel 20A and the gripping arms 20B-1 and 20B-2 such that the gripping panel 20A and the gripping arms 20B-1 and 20B-2 resiliently flex to accommodate, and securely grip the substantially horizontal planar structure.

In some embodiments, the one or more gripping elements may be suitably textured to maximize friction between the substantially horizontal planar structure and the one or more gripping elements. In some embodiments, the one or more gripping elements may have a substantially corrugated texture.

In some embodiments, the one or more gripping elements may extend from an edge of the back plate 12, as illustrated in FIGS. 5A to 5C. In other embodiments, the one or more gripping elements may extend from the middle of the back plate 12. Each of the one or more gripping elements may be separated by a distance that is substantially equivalent to the thickness of the substantially horizontal planar structure.

One or more of the gripping elements may include a gripping ledge 21, such as gripping ledges 21-1 and 21-2 corresponding to gripping arms 20B-1 and 20B-2 respectively. In such embodiments, the gripping ledge 21 may securely engage with the substantially horizontal planar structure and prevent the substantially horizontal planar structure from slipping out from the one or more gripping elements. In some embodiments, the gripping ledge 21 may be configured on the distal ends of the gripping arms 20B-1 and 20B-2.

The one or more gripping elements may grip the substantially horizontal planar structure to secure the holder 10 to the music stand 30. In such embodiments, the weight of the holder 10 and the music equipment 40 placed therein is supported by the one or more gripping elements. In the exemplary embodiment illustrated in FIGS. SA to 5C, the weight of the holder 10 may be supported on distal ends of the gripping arms 20B-1 and 20B-2, and a proximal end of the gripping panel 20A.

In some embodiments, the back plate 12 may include one or more structural ribs 19, such as structural ribs 19-1 and 19-2. The one or more structural ribs 19 may have a plurality of patterns and orientations to reinforce the structural integrity of the back plate 12. In some embodiments, the one or more structural ribs 19 may be joined with the one or more gripping elements. In such embodiments, the one or more structural ribs 19 may be configured to bias the one or more gripping elements to be resilient.

In an example, the one or more structural ribs 19-1 and 19-2 may be affixed to the gripping arms 20B-1 and 20B-2 respectively. The structural ribs 19-1 and 19-2 may be affixed on a surface of the corresponding gripping arms 20B-1 and 20B-2, that is opposite to the surface of the gripping arms 20B-1 and 20B-2 on which the substantially horizontal planar structure may be gripped.

When the substantially horizontal planar structure is removed from the one or more gripping elements, the one or more structural ribs 19 may bias the gripping elements to be resilient, or return to their original shapes and orientation. In some embodiments, the contours and dimensions of the one or more structural ribs 19 may be suitably adapted to reinforce resiliency of the one or more gripping elements based on requirements.

The holder 10 may be made from a plurality of materials. In some embodiments, the holder 10 may be made from any one or combination of including, but not limited to, metal, plastic, wood, plaster, and the like. In an example, the holder 10 may be made of acrylonitrile butadiene styrene plastic. In some embodiments, the holder 10 may be manufactured by means including, but not limited to, additive manufacturing, injection molding, blow molding, and the like.

In some embodiments, the holder 10 may be placed on top of the support structure 32 of the music stand 30. In other embodiments, the set of mounting structures may be configured to allow the holder 10 to be secured to any of the plurality of foldable arms 34 of the music stands 30. The holder 10 may be secured using the set of mounting structures, such as the one or more magnetic members 26 configured thereto. In yet other embodiments, the holder 10 may be secured to the substantially horizontal planar structure, such as the tray 36, of the music stand 30 by the one or more gripping elements. Once secured, the music equipment 40, such as a tuner for example, may be placed into the holder 10. The music equipment 40 may be supported within the space formed by the back plate 12, base ledge 14 and the front panel 16, thereby allowing the music equipment 40 to be supported on the music stand 30.

In some embodiments, the holder 10 may include at least one of: the set of mounting structures, the one or more gripping elements, or the support panel 18 joined to the back plate 12 by the support ledge 17, for securing the holder 10 to any of one or more portions of the music stand 30. The set of mounting structures may allow the holder 10 to be configured to the support structure 32 of foldable music stands 30. The one or more gripping elements may allow the holder 10 to be secured to any horizontal planar structure of the music stand 30. The support panel 18 may allow the holder 10 to be secured to any vertical planar structure of the music stand 30.

In some examples, the holder 10 may have one or more of the aforementioned means of securement. In such examples, the holder 10 may be removed from a first portion of the music stand 30, such as from the tray 36 initially gripped by the one or more gripping elements, and secured to a second portion of the music stand 30, such as the support structure 32 via the one or more magnetic members 26. Such holders 10 may also provide for improved versatility in application by allowing the holders 10 to be securable to a first music stand indicative of a wired stand via the magnetic members 26, as well as to a second music stand indicative of a conducting stand via the one or more gripping elements or the support panel 18.

The instant disclosure provides a holder for supporting a music equipment to a music stand. The holder may also be suitably adapted to accommodate including, but not limited to, musical instruments, tuners, smartphones, electronic display devices, handheld electronic devices, microphones, mixers, amplifiers, speakers, musical notes book, or any other article or device having a form factor corresponding to the holder. The holder may be reversibly secured to including, but not limited to, wired or foldable music stands, tripod music stands, desk stands, conducting stands, or the like. The holder prevents the music equipment from slipping or falling out therefrom. The holder, by being configured on music stands, promotes performers to have an ergonomic posture during performances, and prevents consequent strain and injuries. Further, the holder as disclosed is compact, affordable, portable, easy to operate, and simple in construction and configuration. The holder may be attached to music stands of a plurality of specifications and dimensions. The holder may also support music equipment of a plurality of specifications and dimensions thereon.

Although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

The skilled person will be aware of a range of possible modifications of the various embodiments described above. Accordingly, the present disclosure is defined by the claims and their equivalents.

What is claimed is:

1. A music equipment holder for a music stand, comprising:
a back plate and a front panel joined by a base ledge for supporting a music equipment therebetween, the back plate having a set of mounting structures that reversibly secure the back plate to a support structure of the music stand.

2. The holder of claim 1, wherein the back plate comprises a set of abutments that securely engage with the music equipment to prevent the music equipment from falling off from the holder.

3. The holder of claim 2, wherein each abutment from the set of abutments is configured on a perimeter of the back plate.

4. The holder of claim 1, further comprising a support panel joined to the back plate by a support ledge such that the holder is reversibly securable to the music stand by fitting a vertical planar structure of the music stand between the support panel, the support ledge and the back plate.

5. The holder of claim 4, wherein the base ledge and the support ledge are separated by a predetermined distance to allow an elongated structure to be fitted therebetween.

6. The holder of claim 4, wherein the back plate comprises a protruding ledge that engages with the vertical planar structure such that the back plate, the support panel, the support ledge, and the protruding ledge are capable of reversibly gripping the vertical planar structure therebetween to secure the holder to the music stand.

7. The holder of claim 1, wherein the set of mounting structures is selected from a group comprising magnetic members, screws, nails, rivets, adhesives, hook and loop fasteners, hook and slot fasteners, friction-grip releasable fasteners, and fastening strips.

8. The holder of claim 1, wherein the set of mounting structures comprise one or more protrusions on a mounting surface of the back plate, the one or more protrusions being contoured to receive and secure the holder with the support structure of the music stand.

9. The holder of claim 1, wherein the set of mounting structures comprises one or more magnetic members fastened to the back plate, for magnetically securing the back plate to the support structure of the music stand.

10. The holder of claim 9, wherein the one or more magnetic members are fastened to the back plate by a fastener.

11. The holder of claim 9, wherein the one or more magnetic members are fitted into one or more protrusions on the back plate.

12. The holder of claim 9, wherein the support structure comprises a corresponding set of magnetic members that magnetically engage with the one or more magnetic members of the holder.

13. The holder of claim 1, wherein the back plate comprises one or more cavities that allow a set of flexible elements to be connected to the music equipment through said back plate.

14. The holder of claim 1, wherein the set of mounting structures comprises one or more gripping elements extending from the back plate, wherein the one or more gripping elements are capable of reversibly gripping a horizontal planar structure of the music stand.

15. The holder of claim 14, wherein the one or more gripping elements comprise at least one gripping panel and at least one gripping arm that resiliently grip the horizontal planar structure of the music stand therebetween.

16. The holder of claim 14, wherein the back plate comprises one or more structural ribs configured to bias the one or more gripping elements to be resilient.

17. The holder of claim 14, wherein each of the one or more gripping element comprises a corresponding gripping ledge that prevent the horizontal planar structure from slipping out therefrom.
